(19) United States
(12) Patent Application Publication
(10) Pub. No.: US 2016/0016249 A1
(43) Pub. Date: Jan. 21, 2016

(54) WELDING PROCESS WIRE FEEDER ADAPTER

(71) Applicant: ILLINOIS TOOL WORKS INC., Glenview, IL (US)

(72) Inventors: Brian Randall Bellile, Greenville, WI (US); Alan Edward Stein, Little Chute, WI (US)

(21) Appl. No.: 14/334,397

(22) Filed: Jul. 17, 2014

(51) Int. Cl. B23K 9/10; B23K 9/32; B23K 9/173; B23K 9/133; B23K 9/167

(52) U.S. Cl. CPC B23K 9/1006; B23K 9/133; B23K 9/167; B23K 9/173; B23K 9/323

(57) ABSTRACT

A welding system may include a welding power source that provides power for both a gas metal arc welding (GMAW) process and a gas tungsten arc welding (GTAW) process. Further, the welding system may include a wire feeder coupled to the welding power source for providing wire, gas flow, and electrical current flow for the GMAW process. Additionally, the welding system may include an adapter that couples to the wire feeder to provide the electrical current flow and the gas flow for the GTAW process.

### BACKGROUND

The invention relates generally to welding systems, and, more particularly, to an adapter for transitioning between various welding processes while using a wire feeder to provide power and welding consumables to the various welding processes.

Welding is a process that has increasingly become ubiquitous in various industries and applications. While such processes may be automated in certain contexts, a large number of applications continue to exist for manual welding operations. Such welding operations rely on a variety of types of equipment to ensure that the supply of welding consumables (e.g., wire feed, shielding gas, etc.) provides an appropriate amount of the welding consumables at a desired time to the weld. For example, a gas metal arc welding (GMAW) system typically relies on a wire feeder assembly to ensure a proper wire feed, a proper gas flow, and a stable power supply reach a welding gun, while a gas tungsten metal arc welding (GTAW) system typically relies on a power supply assembly to ensure a proper gas flow and a stable power supply reach a welding torch. Further, a shielded metal arc welding (SMAW) system typically relies on a power supply assembly to ensure a stable power supply reaches a welding torch.

The wire feeder of the GMAW system may generally provide the welding consumables and power from an output of the wire feeder to a GMAW torch or “gun” used to create a GMAW weld. It may be advantageous for the wire feeder to provide a source of gas flow and power from the output of the wire feeder to a GTAW system and also to provide power from the output for an SMAW system. However, various welding processes may have incompatible devices that may make sharing a common consumable and power source difficult.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a welding system may include a welding power source that provides power for both a gas metal arc welding (GMAW) process and a gas tungsten arc welding (GTAW) process. Further, the welding system may include a wire feeder coupled to the welding power source for providing wire, gas flow, and electrical current flow for the GMAW process. Additionally, the welding system may include an adapter that couples to the wire feeder to provide the electrical current flow and the gas flow for the GTAW process.

In a second embodiment, an adapter may include a coupling portion that is received in a gas metal arc welding (GMAW) wire drive assembly. Additionally, the coupling portion may receive power from the GMAW wire drive assembly. Further, the adapter may include a receiving portion that may couple with a connector of a gas tungsten arc welding (GTAW) system to provide the power to the GTAW system from the GMAW wire guide assembly.

In a third embodiment, a method for performing a welding operation may include coupling a gas tungsten arc welding (GTAW) system adapter to a gas metal arc welding (GMAW) wire drive assembly to provide electrical current and gas flow for a GTAW welding operation. Further, the method for performing a welding operation may include coupling a GTAW welding cable machine connector to the GTAW system adapter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an exemplary welding system utilizing a wire feeder with the option of coupling a gas metal arc welding (GMAW) system or a gas tungsten arc welding (GTAW) system to the wire feeder;

FIG. 2 is a front view of an exemplary embodiment of certain components of the wire feeder of FIG. 1 coupled to the GMAW system of FIG. 1;

FIG. 3 is a partially exploded front view of an exemplary embodiment of certain components of the wire feeder of FIG. 1 and the GTAW system of FIG. 1;

FIG. 4 is a perspective view of an exemplary adapter that enables coupling of the wire feeder of FIG. 1 to the GTAW system of FIG. 1; and

FIG. 5 is a cross-sectional view of the adapter of FIG. 4.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments are directed to an adapter for a welding system that may enable various welding processes not requiring a wire feed to function with a welding wire feeder as a power source or a power and gas source. In typical wire feeders, an output may provide welding wire, a gas flow, and power to a gas metal arc welding (GMAW) torch or “gun”. Further, in multi-process welding machines, there may be several different connections for the different welding processes that the machine may perform. To increase the versatility of a GMAW wire feeder, an adapter, described in detail below, may be positioned in a wire drive assembly of the wire feeder to provide a power source and a gas source to a gas tungsten arc welding (GTAW) torch or “gun”, or to provide a power source for a shielded metal arc welding (SMAW) torch or “gun”. In this manner, multiple welding processes may be accomplished using the individual wire drive assembly of the wire feeder.

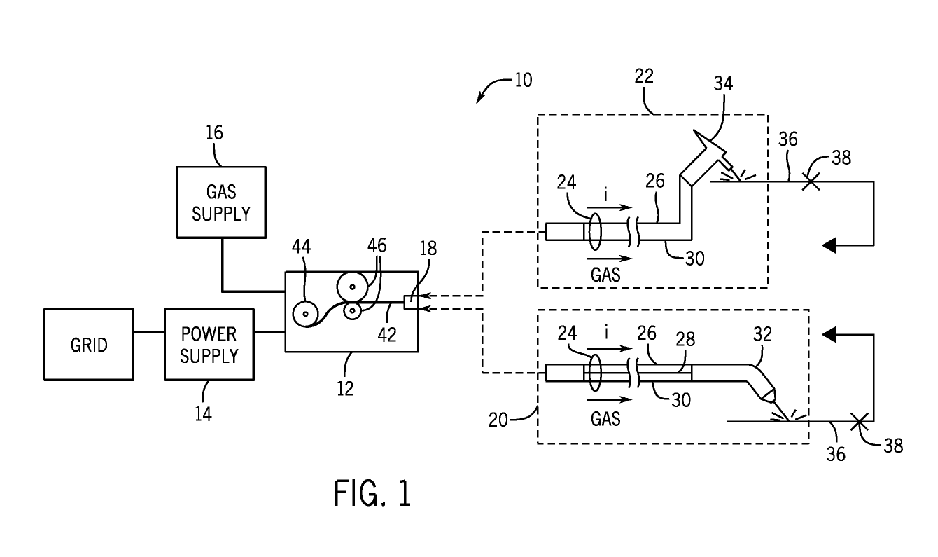

FIG. 1 is a block diagram of an embodiment of a welding system 10 in accordance with the present techniques. The welding system 10 may produce a welding arc on a workpiece via a welding gun or a welding torch. The welding arc may be of any type including a GMAW, a GTAW, an SMAW, and so forth. Further, the welding system 10 may include a wire feeder 12 coupled to a power supply 14 and a gas supply 16. The power supply 14 may receive power directly from a grid. Additionally, the power supply may receive power from a generator capable of providing adequate power to the power supply 14 to power the welding system 10. The gas supply 16 may provide a source of shielding gas to the wire feeder 12. Applying the shielding gas to a weld area on a workpiece may shield a weld from the surrounding atmosphere that may cause imperfections during a welding process. Further, the wire feeder 12 may include a wire drive which drives wire from a wire spool toward a weld site during a GMAW operation.

In the present embodiment, a wire drive assembly 18 of the wire feeder 12 may receive a GMAW system 20 or a GTAW system 22 via welding cables 24. While the GMAW system 20 and the GTAW system 22 are illustrated in FIG. 1, it should be noted that several other welding processes (e.g., a shielded metal arc welding (SMAW) system) may also be capable of coupling to the wire feeder 12 in a similar manner to the GTAW system 22, as discussed below. It should also be noted that the power supply 14 may be capable of supplying power for a GMAW system 20, a GTAW system 22, or any other compatible welding process.

For the GMAW system 20, the welding cable 24 may supply a current flow 26, wire 28, and a gas flow 30 to a GMAW welding gun 32 from the wire feeder 12. Should the GTAW system 22 replace the GMAW system 20, the wire feeder 12 may supply only the current flow 26 and the gas flow 30 to a GTAW torch 34 via the welding cable 24. Therefore, a wire supply system within the wire feeder 12 may be disabled when the GTAW system 22 couples to the wire feeder 12. Further, as mentioned above, the SMAW system (not shown), or any other welding process, may also be coupled to the wire feeder 12. When the SMAW system is in place, the wire feeder 12 may supply only current flow 26 due to flux coating a consumable electrode in the SMAW system. The flux may create a shielding vapor without the use of the gas supply 16 during an SMAW weld. Therefore, when the SMAW system couples to the wire feeder 12, both the wire drive system and a gas supply system within the wire feeder 12 may be disabled.

Further, the GMAW system 20 and the GTAW system 22 may conduct welds on workpieces 36. During a welding operation, grounding clamps 38 may clamp to the workpieces 36. The grounding clamps 38, as illustrated, may provide a path to ground for the workpieces 36, and the grounding clamps 38 may also complete a welding circuit for the GMAW system 20 and the GTAW system 22. By completing the welding circuit, the grounding clamps 38 may enable generation of an arc from the GMAW welding gun 32 or the GTAW welding torch 34 to the workpieces 36.

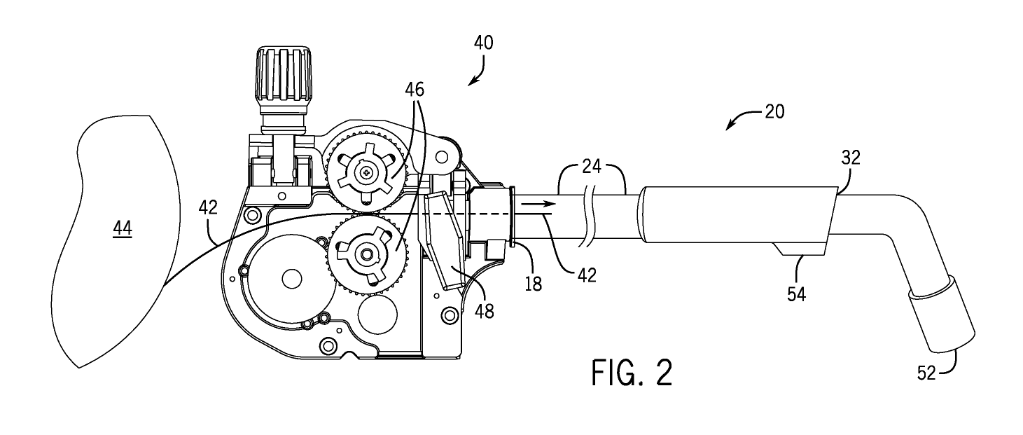

Turning now to FIG. 2, a front view of an exemplary embodiment of certain components of the wire feeder 12 coupled to the GMAW system 20 is illustrated. Generally, in the GMAW welding system 20, the wire drive system 40 of the wire feeder 12 may provide a mechanism for feeding the wire 28 toward the GMAW welding gun 32 from a wire spool 44. A feed motor (not shown) within the wire drive system 40 may mechanically couple to the drive wheels 46. The drive wheels 46, in turn, may drive the wire 28 from the wire feeder 12 toward the GMAW welding gun 32. Further, the welding cable 24 that may provide the current flow 26, the wire 28, and the gas flow 30 to the GMAW welding gun 32 may couple securely to the wire feeder 12 via a tightening screw 48. Furthermore, a wire drive assembly 18 may couple with a machine connector portion of the welding cable 24 at the wire feeder 12. The wire drive assembly 18 may provide a location to receive the machine connector portion of the welding cable 24 at the wire feeder 12 enabling the secure coupling of the welding cable 24 to the wire feeder 12 using the tightening screw 48.

Additionally, the GMAW welding gun 32 may include a nozzle 52 that directs the wire 28 and the gas flow 30 toward the workpiece 36 and facilitates generation of the welding arc from the current flow 26. A trigger 54 on the GMAW welding gun 32 may instruct the wire feeder 12 to supply the current flow 26, the wire 28, and the gas flow 30 to the nozzle 52. In this manner, a welding operator may manipulate operation of the GMAW system 20 to produce a desired weld on the workpiece 36.

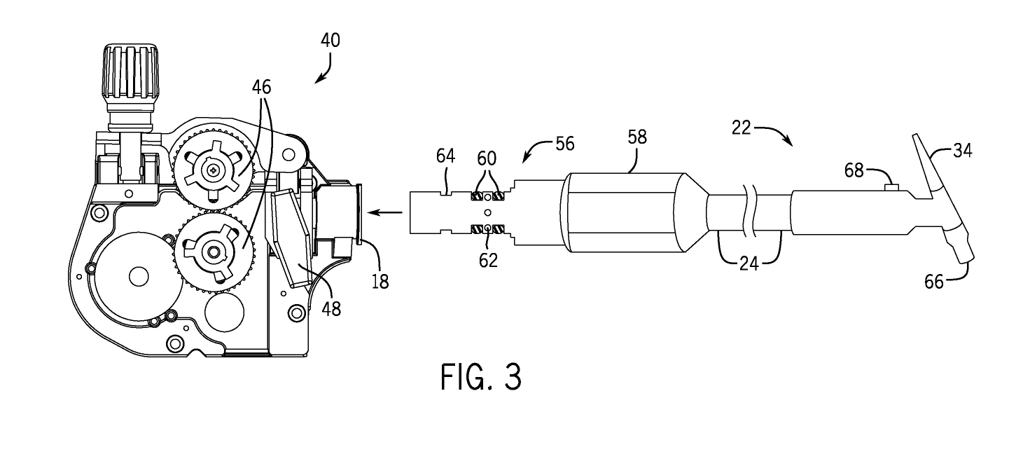

FIG. 3 is a front view of an exemplary embodiment of certain components of the wire feeder 12 coupled to the GTAW system 22. The GTAW system 22 may couple to the wire feeder 12 at the wire drive assembly 50 via an adapter 56. During operation of the GTAW system 22, the adapter 56 may be positioned in the wire drive assembly 18 and held in place by the tightening screw 48 to create a secure connection between the adapter 56 and the wire feeder 12. An opposite end of the adapter may receive a cable machine connector 58 coupled to the welding cable 24. The cable machine connector 58 may provide similar connection capabilities as a standard cable machine connector for coupling a welding cable to a standard GTAW power source. In this embodiment, only the adapter 56 is used in addition to the cable machine connector 58 when coupling the GTAW system 22 to the wire feeder 12 that typically provides power and expendables (e.g., gas flow and wire 42) to the GMAW system 20.

Additionally, in some embodiments, the adapter 56 may be permanently affixed to a welding cable 24. In such an embodiment, the welding cable 24 may bypass the machine connector 58 and permanently couple with the adapter 56. The resulting adapter 56 and welding cable 24 device may provide a mechanism for a welding operator to efficiently transition between operating the GMAW system 20 and the GTAW system 22. Further, a welding operator welding primarily with the GMAW system 20, and generally having access to only the wire feeder 12 as a power source, may find a lesser burden to perform a weld with the GTAW system 22 when the adapter 56 is permanently affixed to the welding cable 24.

Furthermore, the adapter 56 may be made from a conductive material (e.g., brass) to conduct the current flowing from the power supply 14 through the wire feeder 12 and provide the current to the GTAW torch 34 to generate an arc at the workpiece 36. A suitable conductive material may carry a current desired for the GTAW system 22. Therefore, the adapter 56 may generally consist of a metallic material. Further, a single piece of the suitable conductive material may form the adapter 56.

Moreover, the adapter 56 may include o-rings (or other seals) 60 positioned on the body of the adapter. The o-rings 60 positioned on one or both sides of gas through-ports 62 may prevent shielding gas leakage from the gas supply 16 as the shielding gas flows through the wire drive assembly 18 toward the GTAW torch 34. Preventing the shielding gas leakage may heighten the gas flow and reduce consumables cost during a welding operation. Further, a recess 64 that encircles the adapter 56 may provide stability for the adapter 56. The tightening screw 48 may interact with the recess 64 during tightening of the tightening screw 48. With this interaction, the tightening screw 48 may secure the adapter 56 in a position coupled to the wire drive assembly 50. Upon tightening the tightening screw 48, the screw may fit within the recess 64 and apply pressure against an inner surface of the recess 64. The applied pressure may render the adapter 56 substantially secure within the wire drive assembly 50. In the illustrated embodiment, the recess 64 encircles the entire adapter 56. However, it may be appreciated that in some embodiments the recess 64 may be a single location on the adapter 56 that receives the tightening screw 48. In this situation, the recess 64 may be designed to couple with specific wire drive assemblies 50 or tightening screws 48.

Upon coupling the welding cable 24 to the power supply 14 via the wire feeder 12, the GTAW torch 34 may operate in a desired manner. For example, the adapter 56 may electrically couple with the wire drive assembly 18 to provide adequate power through the welding cable 24 and toward a nozzle 66. The power supplied at the nozzle 66 may enable arcing at the work piece interacting with a filler rod to create a desired weld bead. Further, shielding gas may flow from the gas supply 16 to the GTAW torch 34 via a gas output of the wire drive assembly 18. The shielding gas may flow from the gas output, through the gas through-ports 62 of the adapter 56 into the welding cable 24, and, ultimately, out of the nozzle 66 to shield the weld produced by the GTAW torch 34. The adapter 56 may contain one or more of the gas throughports 62 to help facilitate the gas flow from the wire feeder 12 to a GTAW torch 34. Furthermore, the GTAW torch 34 may have a trigger 68 or a pedal (not shown) to control the current flow and the gas flow through the torch and toward the workpiece 36. In this manner, a welding operator may adjust welding parameters output by the wire feeder 12 in a similar manner to a traditional GTAW power and gas source.

Further, to couple the adapter 56 to the wire drive assembly 18, a machine connector portion of the welding cable 24 of the GMAW system 20 may first be removed from the wire drive assembly 18 by loosening the tightening screw 48 and pulling the welding cable 24 away from the wire drive assembly 18. Subsequently, the wire drive assembly 18 may receive the adapter 56 with or without the machine connector 58 already coupled to the adapter 56. Once the adapter 56 is in place, the tightening screw 48 may securely hold the adapter 56 in position within the wire drive assembly 18.

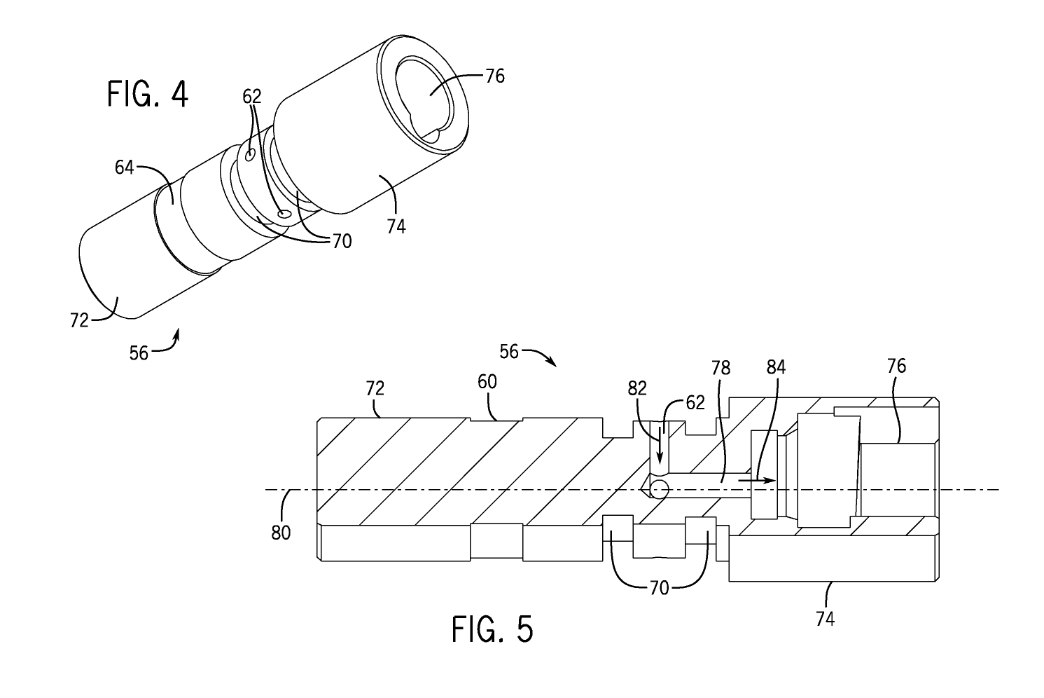

FIG. 4 is a perspective view of the adapter 56. In the illustrated embodiment of the adapter 56, o-ring recesses 70 are shown on either side of the gas through-ports 62. The o-ring recesses 70 may be formed in the body of the adapter 56 to secure positioning of the o-rings 60 shown in FIG. 4. By inserting the o-rings 60 into the o-ring recesses 70, the o-rings 60 may remain substantially stationary when inserting or removing the adapter 56 from the wire drive assembly 18. In this manner, the o-rings 60 may maintain a seal between the adapter 56 and the gas output of the wire drive assembly 18 to prevent any substantial leakage of the shielding gas. As mentioned above, this may reduce costs associated with welding consumables during a welding operation.

Additionally, the adapter 56, as illustrated in FIG. 4, has a coupling portion 72 that may comprise a solid portion of the conductive material that makes up the adapter 56. The coupling portion 72 may have a generally cylindrical shape and function as a male configuration of a size that would enable a close fit within walls of the wire drive assembly 18. Contact between the wire drive assembly 18 and the coupling portion 72 may result in the efficient transfer of current from the wire feeder 12 to the GTAW system 22. Additionally, to enhance contact between the wire drive assembly 18 and the coupling portion 72, the recess 64 may receive the tightening screw 48 to press the adapter 56 into the walls of the wire drive assembly 18 and enhance a secure electrical connection between the wire drive assembly 18 and the coupling portion 72.

Upon establishing the secure electrical connection between the wire drive assembly 18 and the coupling portion 72, the electrical current and the gas flow may travel toward a receiving portion 74 of the adapter 56. The receiving portion 74 may generally comprise a larger diameter than the coupling portion 72 and also comprise a female configuration via a receiving aperture 76. Further, the receiving aperture 76 positioned within the receiving portion 74 may receive the machine connector 58. The machine connector 58 may couple the adapter to the welding cable 24 to transmit the current and gas flow toward the GTAW torch 34.

Further, as mentioned above, the receiving portion 74 may also remain permanently affixed directly to the welding cable 24. In this embodiment, the welding cable 24 may functionally operate as the receiving portion 74 of the adapter 56. Instead of coupling the machine connector 58 to the receiving portion 74, the GTAW torch 34 may couple directly to the receiving portion 74 of the adapter 56. This embodiment may enable an increase in efficiency in transitioning between the GMAW system 20 and the GTAW system 22 by eliminating a step to couple the welding cable 24 to the machine connector 48. Further, such an embodiment may be attractive to a welding operator that only owns a GMAW welding machine and has little need for the welding cable 24 capable of coupling to a GTAW welding machine.

FIG. 5 is a cross-sectional view of the adapter 56. In the illustrated embodiment, the receiving aperture 76 is in fluid communication with the gas through-ports 62 by way of an inner gas flow path 78. The gas through-ports 62, in the illustrated embodiment, are positioned radially in relation to a central axis 80 of the adapter 56. It may be noted, however, that the gas through-ports 62 may also intersect the central axis 80 at a non-perpendicular angle so long as resulting angle does not impede the gas flow. Further, the inner gas flow path 78, in the present embodiment, is positioned along the central axis 80 within the adapter 56. Similarly to the gas through-ports 62, the inner gas flow path 78 may also be placed within the adapter 56 at any angle relative to the central axis 80 (i.e., not simply parallel to the central axis 80) of the adapter 56 so long as a resulting position of the inner gas flow path 78 does not impede the gas flow.

Further, as illustrated in FIG. 5, arrows 82 and 84 represent the flow direction of the gas from the wire drive assembly 18 toward the welding cable 24. The shielding gas may flow from the wire drive assembly 18 through the gas through-ports 62 in the direction of arrow 82 toward the central axis 80. Upon reaching the inner gas flow path 78, the shielding gas may flow along the central axis 80 in the direction of arrow 84 toward the receiving aperture 76. The shielding gas may then flow into the welding cable 24 before the GTAW torch 34 applies the shielding gas at the site of a weld.

Additionally, in some embodiments, the gas through-ports 62 and the inner gas flow path 78 may not be present. Such an embodiment may be used with an SMAW system or any other welding system that may not use shielding gas from the gas supply 16. For example, in the SMAW system, the flux coating the consumable electrode creates the shielding gas during welding. Because of this, the SMAW torch does not provide the shielding gas during a weld. This may result in disabling both the gas source 16 and the wire drive system 40 while the SMAW system is in place. Further, coupling the SMAW system to the wire drive assembly 18 may allow the adapter 56 to operate without the gas through-ports 62 and the inner gas flow path 78. Instead, the adapter 56 may comprise a single, solid piece of brass or other conductive material throughout with a recess for the receiving aperture 76.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system, comprising:
a welding power supply configured to provide power for both a gas metal arc welding (GMAW) process and a gas tungsten arc welding (GTAW) process;
a wire feeder coupled to the welding power supply for providing wire, gas flow, and electrical current flow for the GMAW process; and
an adapter configured to couple to the wire feeder to provide the electrical current flow and the gas flow for the GTAW process.

2. The welding system of claim 1, wherein the wire feeder comprises a wire drive assembly to facilitate feeding the wire to a GMAW gun, and wherein the adapter is configured to couple to the wire feeder during the GTAW process in place of the wire drive.

3. The welding system of claim 1, wherein a wire feeding function of the wire feeder is disabled when the adapter is in place during the GTAW process.

4. The welding system of claim 1, wherein a first cable for a GMAW gun and a second cable for a GTAW torch couple to the wire feeder in substantially the same location.

5. The welding system of claim 4, wherein the second cable couples to the adapter at a first end and the GTAW torch at a second end.

6. The welding system of claim 4, wherein the second cable is permanently affixed to the adapter.

7. The welding system of claim 1, wherein the adapter comprises at least one gas through-port to facilitate the gas flow from the wire feeder to a GTAW torch.

8. The system of claim 1, comprising a tightening screw within the wire feeder, wherein the tightening screw is configured to hold a GMAW cable in a position coupled to the wire feeder during the GMAW process and to hold the adapter in a position coupled to the wire feeder during the GTAW process.

9. The welding system of claim 1, wherein the adapter is made of a conductive material that facilitates the flow of current from the wire feeder to a GTAW torch.

10. The welding system of claim 1, wherein the adapter is further configured to provide the electrical current flow for a shielded metal arc welding (SMAW) process.

11. An adapter, comprising:
a coupling portion configured to be received in a gas metal arc welding (GMAW) wire drive assembly and to receive power from the GMAW wire drive assembly; and
a receiving portion configured to couple with a connector of a welding cable of a gas tungsten arc welding (GTAW) torch to provide the power to the GTAW torch from the GMAW wire drive assembly.

12. The adapter of claim 11, comprising a gas flow path to receive gas flow from the GMAW wire drive assembly, wherein the receiving portion is configured to provide the power and the gas flow to the GTAW torch.

13. The adapter of claim 12, wherein the coupling portion comprises a male configuration, and the receiving portion comprises a female configuration.

14. The adapter of claim 12, comprising at least one o-ring on a side of the gas flow passages.

15. The adapter of claim 12, wherein the gas flow path comprises one or more gas through-ports.

16. The adapter of claim 12, wherein the coupling portion and the receiving portion comprise a single piece of conductive material.

17. The adapter of claim 11, wherein the receiving portion is configured to couple with a connector of an alternate welding cable coupled to a shielded metal arc welding (SMAW) torch to provide the power to the SMAW torch from the GMAW wire drive assembly.

18. The adapter of claim 11, wherein the receiving portion permanently couples to the connector of the welding cable of the GTAW torch.

19. A method for performing a welding operation, comprising:
coupling a gas tungsten arc welding (GTAW) system adapter to a gas metal arc welding (GMAW) wire drive assembly to provide electrical current and gas flow for a GTAW welding operation; and
coupling a GTAW welding cable machine connector to the GTAW system adapter.

20. The method of claim 19, wherein coupling the GTAW system adapter to the GMAW wire drive assembly comprises:
removing a GMAW system machine connector from the GMAW wire drive assembly;
replacing the GMAW system machine connector with the GTAW system adapter; and
tightening the GTAW system adapter in place with a tightening screw of the GMAW wire guide assembly.
